(19) United States
(12) Patent Application Publication
(10) Pub. No.: US 2015/0255068 A1
(43) Pub. Date: Sep. 10, 2015

(54) SPEAKER RECOGNITION INCLUDING PROACTIVE VOICE MODEL RETRIEVAL AND SHARING FEATURES

(71) Applicant: Microsoft Corporation, Redmond, WA (US)

(72) Inventors: Jaeyoun Kim, Bellevue, WA (US); Yaser Masood Khan, Bothell, WA (US); Thomas C. Butcher, Seattle, WA (US); Michael Abraham Betser, Kirkland, WA (US); Srinivas Rao Choudam, Redmond, WA (US)

(73) Assignee: MICROSOFT CORPORATION, Redmond, WA (US)

(21) Appl. No.: 14/203,053

(22) Filed: Mar. 10, 2014

(51) Int. Cl. G10L 17/04; G10L 15/08

(52) U.S. Cl. CPC G10L 17/04; G10L 15/08

(57) ABSTRACT

Embodiments provide voice model and speaker recognition features including proactive retrieval and/or sharing of voice models, but the embodiments are not so limited. A device/system of an embodiment includes speaker recognition features configured in part to proactively retrieve and/or enable sharing of voice models for use in speaker identification operations. A method of an embodiment operates in part to proactively retrieve and/or enable sharing of voice models for use in speaker identification operations. Other embodiments are included.

### BACKGROUND

Voice and speaker recognition paradigms have been widely employed for hands-free device/system interaction. Modern computing devices/systems, such as smartphones and tablet computers for example, are equipped with advanced video and audio processing capability that provides a rich platform for application developers to use when integrating voice activation and interaction features. Speaker recognition systems typically require some type of enrollment or training using a spoken utterance. Some users would prefer not to interrupt a natural flow of conversation to take the time required to enroll and train a voice model for use during speaker recognition.

Some speaker recognition systems operate to provide a recognized speaker's identity name, number, etc. rather than generating a limited allow or deny verification result. Speech-enabled applications exist for various devices/system (e.g., a desktop computer, laptop computer, tablet computer, etc.) and typically require some type of microphone or audio receiver to receive and interpret voice data. As an example, an automated telephone attendant can use a voice model to recognize which user is requesting a service without explicitly requiring a name.

Speech samples can be visualized as waveforms that display changing amplitudes over time. A speaker recognition system can analyze frequencies of the speech samples to ascertain signal characteristics such as the quality, duration, intensity, and pitch. Hidden Markov Models (HMMs) and Gaussian Mixture Models (GMMs) use vector states to represent various sound forms characteristic of a speaker and compare input voice data and vector states to produce a recognition decision that can be susceptible to transmission and microphone noise. However, the present state of speaker recognition systems lack the ability to anticipate and proactively retrieve voice models for use in speaker recognition including using additional information to refine identification of potentially relevant voice models.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide voice model and speaker recognition features including proactive retrieval and/or sharing of voice models, but the embodiments are not so limited. A device/system of an embodiment includes speaker recognition features configured in part to proactively retrieve and/or enable sharing of voice models for use in speaker identification operations. A method of an embodiment operates in part to proactively retrieve and/or enable sharing of voice models for use in speaker identification operations. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram that depicts an exemplary system configured in part to provide proactive voice model retrieval and/or speaker recognition features.

FIG. 2 is a flow diagram depicting an exemplary process of creating and/or updating voice models as part of providing speaker recognition features.

FIG. 3 depicts a process of proactively retrieving voice models.

FIG. 4 is flow diagram depicting an exemplary process used in part to provide voice model sharing services and/or features.

FIGS. 5A-5C depict aspects of using social graph data as part of a speaker recognition process.

FIG. 6 is a block diagram illustrating an exemplary computing environment for implementation of various embodiments.

FIGS. 7A-7B illustrate a mobile computing device with which embodiments may be practiced.

FIG. 8 illustrates one embodiment of a system architecture for implementation of various embodiments.

### DETAILED DESCRIPTION

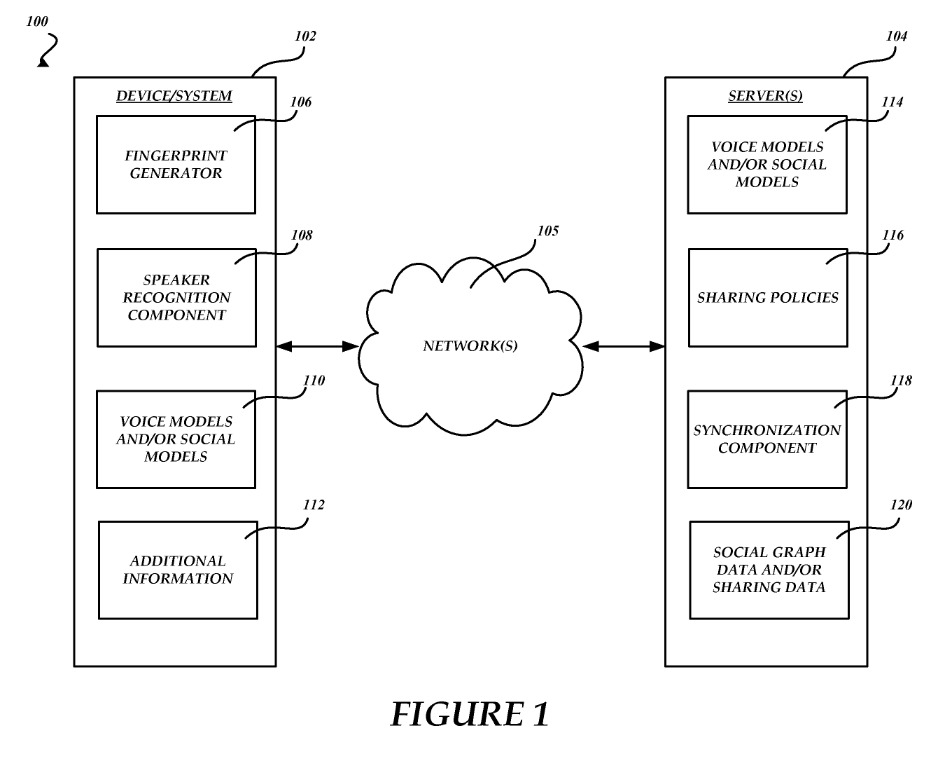

FIG. 1 is a block diagram that depicts an exemplary system 100 configured in part to provide proactive voice model retrieval and/or speaker recognition features, but is not so limited. As shown in FIG. 1, the system 100 includes a client device/system 102 and a server 104 coupled via network 105. As described below, device/system 102 includes video and audio processing capability as well as complex programming that operates in part to automatically generate voice models, share voice models, and/or create social graph models. The server 104 can be used in part to manage voice model policies, including sharing and/or creation polices. The server 104 can also maintain multiple voice models and voice model versions that may be utilized across one or several different device/system types.

As described herein, the device/system 102 can be configured to automatically update user voice models over time. According to an embodiment, the device/system 102 can utilize voice models of different types, such as generic voice models, device-specific voice models, and/or other voice model types. The device/system 102 can operate to update voice models and also create new speaker models using live and/or recorded voice data automatically or semi-automatically (e.g., associate a speaker with contact, associated a speaker with a social graph, associated a speaker with a signal, etc.). As an example, new speaker models can be created that correspond to live speakers and those captured in personal recordings. The device/system 102 and/or server 104 of one embodiment manage different voice model types using a storage format (e.g., generic=[speaker, voice model, timestamp] and device specific=[speaker, voice model, timestamp, device]).

Sharing policies 116 allow users to control sharing of voice models and/or other voice data with other people or groups. For example, a user can set sharing policies for voice models associated with different social networks or use settings (e.g., family, friends, colleagues, etc.). Voice models and/or social models can be stored on a cloud system with encryption for data security and used across different user devices/systems for speaker recognition. As described below, anticipating relevant voice models to retrieve and store locally based on context, such as upcoming calendar, frequently met people, time of day correlations, and/or other signals/data for example, can be useful to reduce an amount of time and processing resources required to recognize a speaker. Multiple voice models can be maintained, and/or and selectively identified for proactive retrieval. Proactive retrieval can include retrieval of locally stored and/or remotely stored voice models.

According to an embodiment, the device/system 102 can be configured to automatically collect/receive voice data, whether live or recorded utterances. As described below, the system 100 can utilize a number of processes as part of providing various voice model and/or speaker recognition features. The system 100 can use additional information, such as additional signals and/or data, as part of proactively identifying and/or retrieving voice models. For example, the additional information 112 can include application data, context data, location data, and/or other information that may be used in identifying pertinent voice models to proactively retrieve.

The device/system 102 of an embodiment can be configured to detect audible utterances, build, manage, and/or share voice models and/or social graphs without or absent requiring any required and potentially intrusive enrollment process. In one embodiment, the device/system 102 operates to continuously detect audible utterances or other sounds as part of building and/or updating voice models with the most up to date information in order to facilitate an efficient speaker recognition process and minimize an amount of time required to identify speakers. For example, an associated audio interface can be configured to collect voice data from speakers who are within detectable range of the audio interface and build and/or update voice models associated with each speaker.

Collected voice data can be analyzed as it is received or stored and analyzed at some later time. Components of the system 100 can operate to build out a voice model collection associated with an owner of device/system 102 as well as building out voice model collections of others associated with an owner of device/system 102. For example, components of the system 100 can operate to use social graph data to automatically retrieve voice models for users associated with an owner of device/system 102 who satisfy some degree of trust or other social dependency. Components of the system 100 can operate further to manage updates and/or changes to social graphs and the associated social graph data.

As shown in FIG. 1, the device/system 102 includes a fingerprint or voice model generator 106, a speaker recognition component 108, voice models and/or social models 110, and/or additional information 112, but is not so limited. As an example, the additional information 112 can include sharing data, social graph data, signal data, and/or other data/parameters that may be used in proactively identifying and/or retrieving voice models and/or performing speaker recognition operations. The additional information 112 can be obtained and/or stored locally with or without receiving data from server 104. For example, and as described further below, the fingerprint generator 106 and/or speaker recognition component 108 can utilize additional information 112 comprising signals such as location information (e.g., GPS or other location data), connectivity information (e.g., peer to peer coupling), incoming signal reception (e.g., audio, video, and/or other signals), and/or other signals/information to narrow down a number of potentially relevant voice models for proactive retrieval and use in recognizing a speaker.

The additional information 112 can include locally and/or remotely stored information, such as application data, metadata, contact information, calendar information, social network information, texting data, email data, etc. Device/system 102 and server 104 exemplify modern computing devices/systems that include advanced processors, memory, applications, and/or other and other hardware/software components that provide a wide range of functionalities as will be appreciated. Example devices/systems include server computers, desktop computers, laptop computers, gaming consoles, smart televisions, smartphones, and the like.

As shown for the exemplary system of FIG. 1, server 104 includes voice models and/or social models 114, sharing policies 116, synchronization component 118, and/or sharing and/or social graph data 120. Depending on the sharing policies 116, one or more of the voice models and/or social models 114 can be identified for proactive retrieval or use and downloaded to a client device/system. As described below, stored voice models and/or social models can be associated with each device/system owner as well as other speakers and their associated devices/systems. Server 104 may include a database or other system that stores and manages parameter associated with the voice models and/or social models 114, sharing policies 116, sharing and/or social graph data 120, as well as other speaker recognition parameters. Server 104 can also be outfitted with voice model creation and/or updating functionality.

The sharing policies 116 of an embodiment can be used in conjunction with opt-out or opt-in data to control creation and/or sharing of voice models, social models, and/or other information used as part of recognizing speakers or providing other services. For example, a sharing policy can use a flag to control sharing of voice models based on whether a user has affirmatively allowed or consented to sharing of his or her voice models. Sharing policies 116 can also be used to control how, if, and/or when social graph data is to be used when generating and/or identifying voice models for proactive retrieval and/or use in recognizing one or more speakers.

As an example, depending on the sharing policy, a social graph associated with a first user may be analyzed to identify potentially relevant voice models of users included in the social graph or users included in other social graphs relative to different users. The synchronization component 118 of an embodiment can be used to synchronize voice models and/or social graph data across all user devices/systems, such that the information is available. The sharing and/or social graph data 120 can be used to control how voice models are to be shared and/or created but can also be used as part of identifying voice models for proactive retrieval.

Voice data collection capabilities of an associated device/system may be used to collect voice data continuously, in a reactionary manner, and/or at particular times such that sufficiently detectable vocalizations are used to create and manage incrementally changing voice model parameters. As described herein, proactively retrieving voice models can result in reductions in processing time and associated resource usage by limiting or eliminating a lengthy/interrupting enrollment process or preempting retrieval of voice models by maintaining certain voice models locally. As such, speaker recognition can be performed locally on device/system 102 absent a server connection in various scenarios and/or engagement environments.

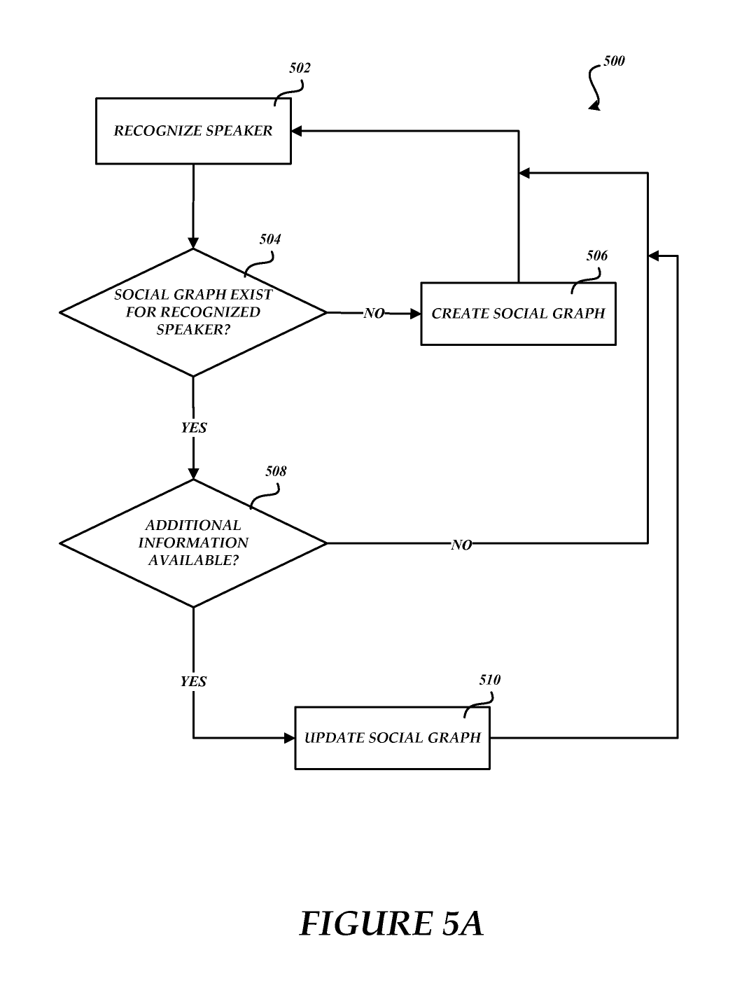

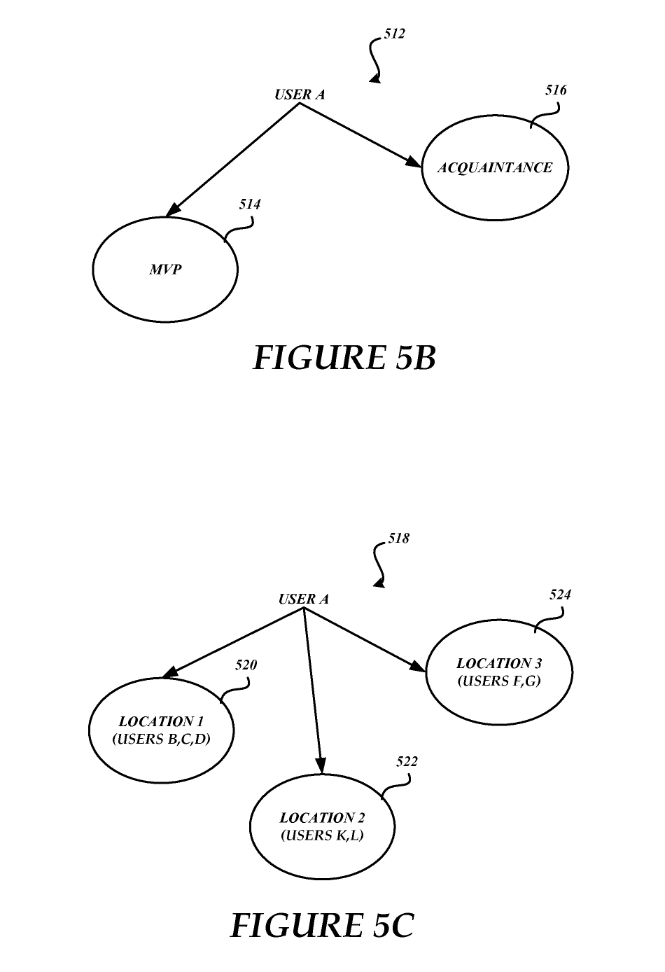

The fingerprint or voice model generator 106 of an embodiment is configured to automatically create a voiceprint or voice model for a user if none exist locally and/or remotely. Depending in part on the voice data collection capabilities of an associated device/system, the fingerprint generator 106 of an embodiment can operate to continuously detect sufficiently detectable vocalizations to create and manage voice model parameters. The fingerprint generator 106 can automatically create new voice models and/or incrementally update/refine existing voice models with new voice data. Graphical representations can be used to display voice model data and/or other data as a social graph depiction (see the examples of FIGS. 5B and 5C).

Each device/system 102 can use one or more multiple voice models 110 depending in part on speaker recognition settings, opt-in/opt-out data, sharing policies, capabilities, device/system type, etc. According to an embodiment, a most appropriate voice model can be retrieved and used based on a particular user device/system. For example, if two voice models were created from the headset microphone and smartphone's microphone, the voice model generated from the smartphone should be used when the user uses the smartphone to recognize speakers. In one embodiment, a sharing policy can be included or associated with a voice model or fingerprint and referred to locally without having to send a request to server 104. Such a local sharing policy can be used to prevent and/or allow peer to peer type voice model sharing. As described above, sharing policies and/or opt-in/opt-out data can also be utilized to control how social data is to be used or shared to proactively identify and retrieve appropriate or pertinent voice models.

In a continuous collection mode, the device/system 102 may not require use of an untimely or potentially disrupting enrollment phase in order to create a voice model. It will be appreciated that an enrollment process requirement can interrupt the natural flow of conversation in business and personal settings. If using the proactive retrieve and/or voice model sharing features, the fingerprint generator 106 and/or speaker recognition component 108 can be configured to require a user's affirmation of consent (e.g., display or audibly issue a prompt to one or more users to provide an assenting audible utterance, check a box and tap to accept, etc.) or require a device/system owner to gain consent before enabling the speaker recognition, voice modelling, and/or other features. Any consenting voice data can be used to build and/or update a voice model collection associated with a speaker. The system 100 provides users an option to opt-in or opt-out of sharing and/or use of voice models at any time.

With continuing reference to FIG. 1, while a limited number of components are shown to describe aspects of various embodiments, it will be appreciated that the embodiments are not so limited and other configurations are available. For example, while a single server 102 is shown, the system 100 may include multiple server computers, including voice and speaker recognition servers, database servers, and/or other servers, as well as client devices/systems that operate as part of an end-to-end computing architecture. It will be appreciated that servers may comprise one or more physical and/or virtual machines dependent upon the particular implementation. For example, server 104 can be configured as a MICROSOFT EXCHANGE server to store voice models, sharing policies, social graphs, and/or other features. According to an embodiment, components may be combined or further divided. For example, features of the fingerprint generator 106 and speaker recognition component 108 can be combined as a single component rather that distinct components.

It will be appreciated that complex communication architectures typically employ multiple hardware and/or software components including, but not limited to, server computers, networking components, and other components that enable communication and interaction by way of wired and/or wireless networks. While some embodiments have been described, various embodiments may be used with a number of computer configurations, including hand-held devices, multiprocessor systems, microprocessor-based or programmable consumer electronics, minicomputers, mainframe computers, etc. Various embodiments may be implemented in distributed computing environments using remote processing devices/systems that communicate over a one or more communications networks. In a distributed computing environment, program modules or code may be located in both local and remote storage locations. Various embodiments may be implemented as a process or method, a system, a device, article of manufacture, etc.

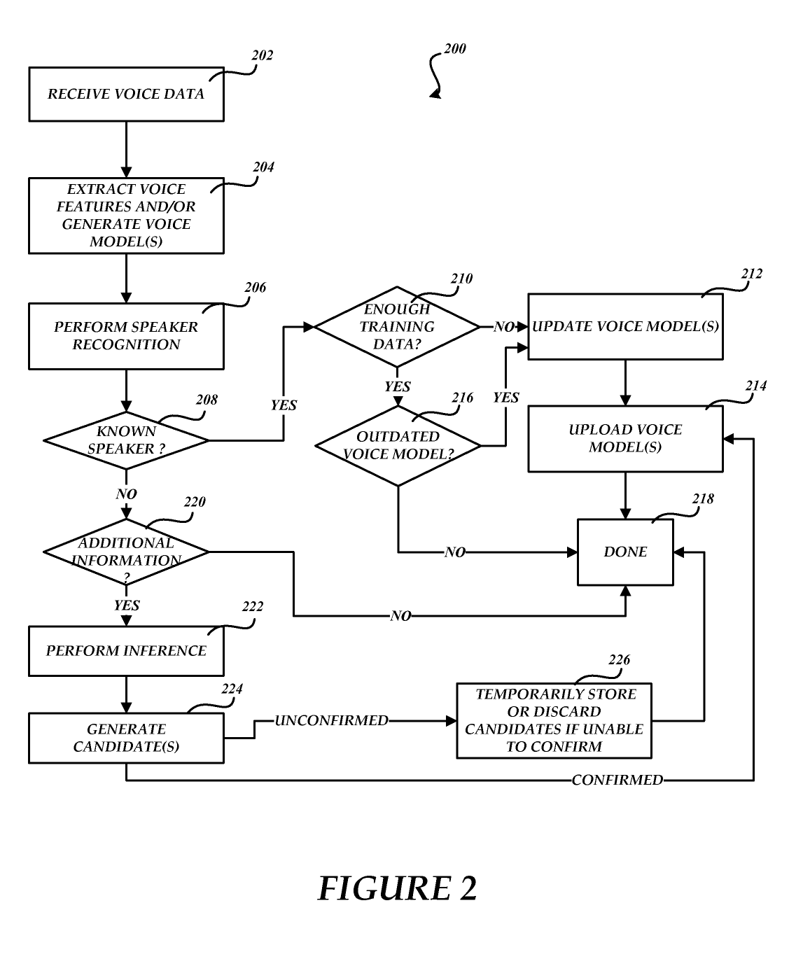

FIG. 2 is a flow diagram depicting an exemplary process 200 of creating and/or updating voice models as part of providing speaker recognition features. It will be appreciated that the processes described herein can be implemented using components of FIG. 1, but are not so limited. The process 200 can be implemented with complex programming as part of a device/system functionality and used to create and/or update voice models as part of recognizing speakers, but is not so limited. According to an embodiment, each device/system can be configured with voice processing and speaker recognition features. For example, a user's smartphone, desktop, laptop, gaming device, etc. can be equipped with voice processing and speaker recognition features that operate to generate voice model parameters and perform speaker recognition operations based in part on one or more voice models. As described below, aspects of the voice processing and speaker recognition features can be implemented locally using the resident processing and memory resources. Server or other networked components can also be utilized to coordinate voice model sharing, updates, synchronizing, etc.

According to an embodiment, the process 200 can be implemented using complex programming code integrated with a user computer device/system that includes audio reception capability (e.g., at least one microphone). In one embodiment, the process 200 operates to automatically detect and process spoken utterances. As shown in FIG. 2, the process 200 at 202 operates to receive voice data. As an example, a user may use a portable device to record a conferencing or brainstorming session such that the process 200 processes different types of voice data according to the type of device/system (e.g., smartphone, landline, desktop, etc.) being used by each participant. The process 200 can operate to process various types of audible utterances, including live voice data and recorded voice data.

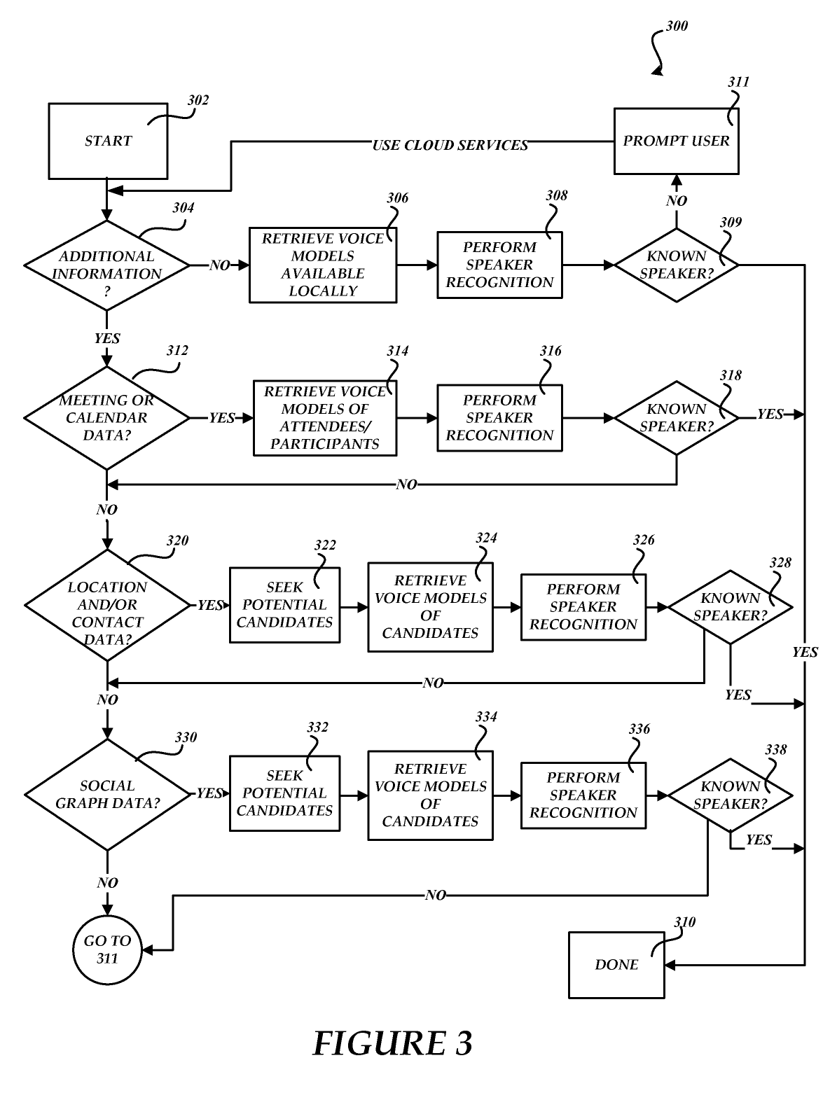

At 204, the process 200 operates to extract voice features from the voice data and/or generate a voice model. It will be appreciated that additional non-voice features may be used in generating voice models, such as noise removal operations for example. For example, the process 200 at 204 can operate to generate a voice model that includes a unique voiceprint for each participant. A voiceprint of an embodiment comprises a small file that includes a speaker's voice characteristics represented in a numerical or other format resulting from complex mathematical processing operations. At 206, the process 200 operates to perform speaker recognition on the voice model. For example, the process 200 at 206 can employ a speaker recognition algorithm on each voice model as part of identifying a speaking participant or speaker, such as Participant A, Participant B, and/or Participant C. Pattern matching techniques can be used to compare the voice data with known voice models to quantify similarities or differences between a voice model and the voice data. Different types of pattern matching techniques are available (HMMs, GMMs, etc.) and can be used analyze the voice data. A speaker recognition process of an embodiment is shown in FIG. 3.

If the process 200 identifies a known speaker at 208, the process 200 at 210 determines if there is enough training data for an associated voice model or models. Alternatively, the training data determination can be bypassed in certain circumstances. If there is sufficient training data at 210, the process 200 of an embodiment continues to 212 and operates to update a generic voice model, device-specific voice model, and/or some other voice model type. It will be appreciated that training data can be used to create a new voiceprint or update an existing voiceprint, whether generated while user(s) are speaking or based on previously collected voice data.

According to one embodiment, voice model updating is performed locally on the associated device/system. Updated voice models can be uploaded to a dedicated server if sharing is allowed. In some cases, a dedicated server can operate to perform voice model updates, alone or in combination, with a client device/system. It will also be appreciated that techniques described herein can be performed in real or near real time. As an example, voice processing operations can be performed in real time such that a user is not required to finish speaking before processing voice data. Voice processing operations of one embodiment can be performed using a batch process to generate a voice or acoustic model once one or more users finish speaking.

At 214, the process 200 operates to upload one or more voice models to a dedicated server if permitted or authorized with or without confirming opt-in data. According to an embodiment, a user may be required to affirmatively allow sharing of voice models before uploads or sharing is allowed. For example, if a user has opted to allow sharing of voice models, not only can other users download the shared voice models, but the sharing user may also be allowed to download voice models of other users who have opted in to voice model sharing. The process 200 at 214 can upload a newer version of a voice model or a new voice model for a newly recognized speaker. If there is sufficient training data at 210 and if the process 200 determines that a voice model is outdated at 216, then the process 200 again proceeds to 212 and so forth. If the voice model is not outdated at 216, the process 200 ends at 218.

If a known speaker was not identified at 208 and if there is no additional information at 220 for inference operations, the process 200 again flows to 218 and ends. In one embodiment, the process 200 at 220 can make a call to one or more servers requesting whether additional information exists. If a known speaker was not identified at 208 and the process 200 at 220 determines that additional information is available for inference operations, the process 200 at 222 operates to perform an inference based on the additional information (e.g., using other remotely and/or locally generated signals and/or other data). For example, the process 200 at 222 can operate to predict an unknown speaker using calendar attendee data of two known speakers scheduled to attend the same meeting.

At 224, the process 200 operates to generate a list of possible candidate speakers based on the inference operations. For example, the process 200 at 224 may refer to social graph data to identify potential candidates having a known trust level or other relationship. The process 200 of one embodiment operates at 224 to identify potential candidates according to a format [candidate voice model, timestamp, device (optional)].

Upon confirming a speaker identity from any potential candidates, the process 200 at 214 of an embodiment operates to upload one or more associated voice models to the dedicated server if the speaker has opted-in to allow the uploading. If an identity of the speaker cannot be confirmed, the process 200 at 226 of one embodiment operates to temporarily store any associated voice models for future confirmations and/or discard any unconfirmed voice models. While a certain number and order of operations are described for the exemplary flow of FIG. 2, it will be appreciated that other numbers, combinations, and/or orders can be used according to desired implementations.

FIG. 3 depicts a process 300 of proactively retrieving voice models. According to an embodiment, in additional to processing spoken utterances, the process 300 of recognizing speakers using a speaker recognition algorithm that utilizes additional information, such as locally stored and/or generated signals and/or data for example, as part of efficiently targeting and retrieving pertinent or relevant voice models. FIG. 3 assumes that at least one spoken utterance has been received and/or recorded. For example, the process 300 can use information associated with a scheduled conference call to proactively retrieve voice models for use during speaker recognition before the call transpires.

Accordingly, performance and/or accuracy of speaker recognition can be improved by predicting voice models to retrieve proactively as a user's context changes. Processing time and power resources can be conserved by proactively retrieving pertinent voice models. The process 300 of an embodiment is configured to perform predictions based in part on user context signals and/or data (e.g. calendar, time, GPS, locations (e.g., home, office, etc.), address book, social graphs, patterns) to identify pertinent voice models. A few examples include: location-based prediction seeking possible candidates whose addresses are within some distance and, if true, automatically storing any associated voice models locally and/or remotely; if a user interacts (e.g., talks, texts, email, etc.) more frequently with specific people during specific times of the day, automatically retrieving any associated voice models for that period of the day (e.g., scrum meeting every morning); building a new social graph based on the speaker recognition results; and/or automatically downloading voice models of meeting attendees using calendar data before or as the meeting begins, just to name a few.

With continuing reference to FIG. 3, the process 300 starts at 302 based on an utterance of at least one speaker (live/recorded). At 304, the process 300 operates to determine if additional information is available that may be utilized in proactively retrieving the appropriate or pertinent voice models. Depending in part on the type of additional information, the process 300 can identify voice models to provide additional focus to the speaker recognition process when recognizing a speaker. While different types of additional information are described, it will be appreciated that other types of information may also be used in the speaker recognition process. For example, additional information may include use of a device Bluetooth signature to suggest a candidate list of nearby persons for use in proactively retrieving one or more voice models. The process 300 of one embodiment can operate to check local and/or remote storage locations for other signals and/or other data that can be used to refine or improve retrieved voice model results.

As shown in FIG. 3, if no additional information is available at 304, the process 300 at 306 operates to retrieve voice models available locally on the device/system. In an embodiment, the process 300 can operate to retrieve voice models stored locally and/or remotely, as well as receiving voice models directly from other user devices/system. At 308, the process 300 operates to perform speaker recognition using any retrieved voice models in attempting to identify the speaker. If the speaker is identified at 309, the process 300 ends at 310. As described herein, many potential subsequent operations or actions can be executed once a speaker is recognized including proactive retrieval of pertinent voice models.

If the speaker is not identified at 309, the exemplary process 300 of one embodiment proceeds to 311 to generate a prompt to inquire if the user would like to use cloud or other services to assist in retrieving any potentially relevant voice models. If the user accepts use of the cloud services, the process 300 operates to identify any additional information for use in identifying pertinent voice models and returns to 304 upon identifying any additional information via cloud services. Otherwise, the process 300 is done at 310.

The process 300 of an embodiment can be configured to automatically create a voice model for a user if none exist locally and/or remotely. Depending in part on the voice data collection capabilities of an associated device/system, the process 300 of one embodiment can operate in continuous, reactionary, and/or periodic voice data collection modes such that sufficiently detectable vocalizations can be used create and manage voice model parameters. The process 300 is configured to create, delete, modify, and/or update voice models on the fly or at predetermined times or situations using live and/or recorded voice data.

With continuing reference to FIG. 3, if there is additional information available to assist with identifying one or more pertinent voice models for proactive retrieval at 304, the process 300 can use a variety of signal and/or data types to enhance the identifying and proactive retrieval of pertinent voice models. As described above, the additional information may also be used as a basis for creating and/or deleting voice models. For example, opt-out data may be used to deny sharing of voice models and/or require deletion of voice models that may have been generated without the consent of a user.

The process 300 of an embodiment uses an explicit multistep procedure to ensure that users knowingly opt-in to voice model creating, use, and/or sharing. In some cases, depending on the circumstances/conditions, multiple voice models may be attributable to a speaker and the process 300 can use the additional information to assist in refining or narrowing potentially relevant voice models for proactive retrieval. It will be appreciated that the process 300 provides one implementation example of a speaker recognition process and other embodiment and implementations are available.

For this implementation example, if the additional information comprises meeting data or calendar type data at 312, the process 300 at 314 operates to retrieve voice models of attendees or principals associated with the meeting or calendar data. At 316, the process 300 operates to perform speaker recognition using any retrieved voice models in attempting to identify the speaker. If the speaker is identified at 318, the process 300 again ends at 310. If the speaker is not identified at 318, the process 300 for this example continues to 320 to determine if the additional information comprises location and/or contact type data.

If the additional information comprises location and/or contact type data, the process 300 proceeds to 322 and seeks potential candidates from an address book or other contact data which may or may not be based on the location data (e.g., address within a certain range of a location (e.g., 60 feet or less)). At 324, the process 300 retrieves voice models associated with any potential candidates. At 326, the process 300 operates to perform speaker recognition using any retrieved voice models in attempting to identify the speaker. If the speaker is identified at 328, the process 300 ends at 310.

If the speaker is not identified at 328, the process 300 according to this exemplary implementation continues to 330 to determine if the additional information comprises social graph data. If the additional information does not comprise social graph data, the process 300 again proceeds to 311 and generates a prompt. If the additional information comprises social graph data, the process 300 proceeds to 332 and seeks potential candidates based on the social graph data which may include the device/system owner social graph data as well as social graph data associated with other users. For example, social graph data of user A may identify user B as a trusted source so that social graph data of user B can be retrieved to identify additional potential candidates.

At 334, the process 300 retrieves voice models associated with the potential candidates. At 336, the process 300 operates to perform speaker recognition using any retrieved voice models in attempting to identify the speaker. If the speaker is identified at 338, the process 300 again ends at 310. If the speaker is not identified at 338, the process 300 of one embodiment flows again to 311 to generate a prompt to inquire if the user would like to use cloud or other services to assist in retrieving any potentially relevant voice models. Additionally, or alternatively, the process at 311 can be configured to check or refer to any other potential sources of additional information in attempting to proactively retrieve pertinent voice models.

While a certain number and order of operations are described for the exemplary flow of FIG. 3, it will be appreciated that other numbers, combinations, and/or orders can be used according to desired implementations. As one example, depending on the particular implementation one type of signal or data may be looked to before another type. For the example of FIG. 3 while calendar type data was checked first, the process at 312 can be configured to check another signal or information type, such as the social, location, and/or other type(s) of data.

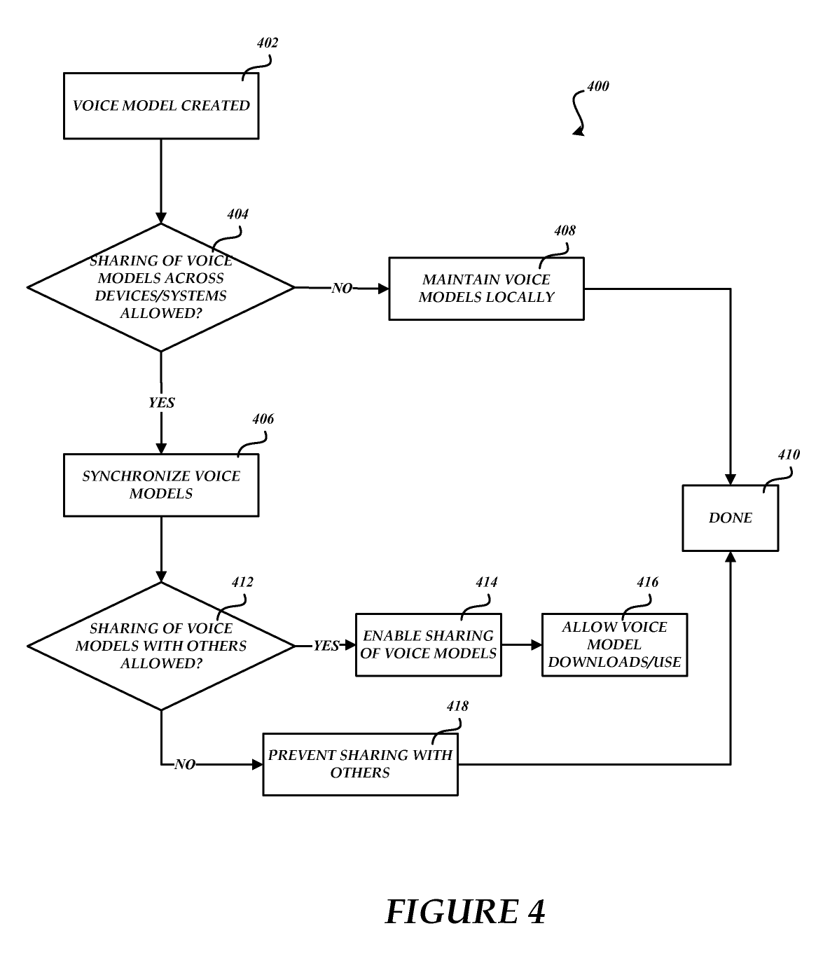

FIG. 4 is flow diagram depicting an exemplary process 400 used in part to provide voice model sharing services and/or features. The process 400 of voice model sharing allows users to share and/or use their voice model across different devices/systems (e.g., desktop computer, laptop computer, tablet computer, smartphone, gaming consoles, office/home phones, etc.). The process 400 can be configured using complex programming that operates with at least one processor to provide rich voice model sharing features including sharing of voice models with specific people and/or trusted groups (e.g., family, colleagues, friends, mutual friends, friends of friends, etc.).

The process 400 enables users to designate how, when, and/or with whom to allow other users to use any associated voice models. For example, the process 400 can be used to allow authorized people and trusted social groups to use shared voice models for speaker recognition and building out voice models for other users associated with a first or other user's trusted circle or social graph type. In one embodiment, an opt-in process can be used to control the sharing of any associated voice models, wherein a dedicated server can be configured to manage sharing and/or opt-in information for multiple users. As described above and further below, additional information, such as social graph data, location signals, etc., can be used in part to track user to user relationships and manage sharing, discovery, and/or proactive retrieval of voice models.

The process 400 at 402 starts when a voice model is created. The process 400 can operate as voice models are created or to share previously created voice models. If the user allows sharing of voice models across various owned or assigned devices/systems at 404, the process 400 operates at 406 to synchronize the user's voice models across all of the associated devices/systems. The process 400 of an embodiment at 406 uses a dedicated voice model sharing server to synchronize the various user models for access and use via the associated devices/systems. If the user does not want sharing of voice models across any of his/her associated devices/systems, the process 400 continues to 408 and operates to prevent uploading of voice models and/or retain the associated voice models on each corresponding device/system, and then the process 400 ends at 410. According to one embodiment, according to group sharing or other policies, a user can request not to allow and/or prevent a device/system to save voice data and/or voice models locally. It will be appreciated that the process 400 can be configured to allow the user to share one or more voice models with other users even though the user may have prevented synchronization of voice models with other devices/systems at 404.

With continuing reference to FIG. 4, if the user allows sharing of voice models with others at 412, the process 400 continues to 414 and makes any associated voice models available generally and/or allows selection of trusted people and/or groups with which to share voice models. The process 400 also allows users to designate particular voice models to share while disallowing sharing of others. The process 400 can also use a global opt-out flag to control sharing of user voice models. At 416, the process 400 allows voice models of the user to be downloaded and/or used for speaker recognition by other users according to any constraints defined at 414 and the process 400 ends at 410.

If the user does not allow sharing of voice models with others at 412, the process 400 continues to 418 and prevents other users from sharing and/or generating voice models associated with the disallowing user and the process 400 ends at 410. While a certain number and order of operations are described for the exemplary flow of FIG. 4, it will be appreciated that other numbers, combinations, and/or orders can be used according to desired implementations. As one implementation example, the process 400 can be used by party or other social event attendees to share voice models with Friends of Friends and recognize each other using speaker recognition and the shared voice models. As another example, voice model can be shared in a peer to peer fashion (e.g., Bluetooth) such that if a user's device detects other speaker recognition capable devices using peer to peer technology, then transmit voice models between the paired devices/systems. For example, capable devices may be physical positioned to contact one another or positioned relative to one another to transfer voice models.

FIGS. 5A-5C depict aspects of using social graph data as part of providing voice model and/or speaker recognition features. FIG. 5A is flow diagram depicting an exemplary process 500 that operates in part to classify voice models and/or generate types of social graphs using social graph data according to an embodiment. At 502, the process 500 operates to recognize a speaker associated with an audible utterance. In an embodiment, the process 500 processes audible utterances using a proactive voice model retrieval and speaker recognition algorithm to process live and/or recorded audible utterances.

If a social graph does not exist for a recognized speaker at 504, the process 500 of an embodiment at 506 operates to automatically create a social graph for the recognized speaker including any appropriate voice model object types, connecting links, levels, and/or groupings. If a social graph does exist for the recognized speaker at 504 and additional information is available at 508, the process 500 at 510 operates to update social graph data and/or one or more social graph depictions/representations using the additional information associated with the recognized speaker. As described above, the additional information may comprise many types of information, whether associated with the recognized speaker and/or other users.

If a social graph does exist for the recognized speaker at 504 and no additional information is available at 508, the process 500 returns to 502. Users can control how and when to update social graph data. In one embodiment, sharing policies can be used to control how social graph data is to be updated or used. For example, a sharing policy can be used to manage social data updates for cases in which a user may not have been recognized as a speaker but social graph data of the user changes anyway.

As described above, depending in part on an associated sharing policy, social graph data may or may not be available for sharing. The social graphs and/or social graph data can be stored locally and/or remotely and used for proactive voice model retrieval, speaker recognition, and/or other tasks. For example, social graph data of users can be used to proactively retrieve voice models before an event such that the proactively retrieved voice models can be used to recognize speakers during the event. FIGS. 5B and 5C depict examples of social graph data representations resulting from use of process 500. While a certain number and order of operations are described for the exemplary flow of FIG. 5A, it will be appreciated that other numbers, combinations, and/or orders can be used according to desired implementations.

FIG. 5B depicts a first type of social graph 512 for user A generated using additional information that comprises speaker recognition history data. Social graph 512 can be used to graphically represent proactively retrieved voice models and/or recognized speakers associated with user A over some amount of time. For example, a recognition threshold can be used (e.g., number of recognitions exceeds a threshold within x number of hours) to classify a voice model as a particular type of voice model (e.g., important (e.g., MVP), trusted, or other voice model classification).

As shown in FIG. 5B, the social graph 512 generated for user A includes an MVP type voice model 514 and an acquaintance type voice model 516. For this example, the MVP type voice model 514 is representative of a speaker who is recognized frequently by one or more of user A devices/systems whereas the acquaintance type voice model 516 is representative of a less frequently recognized speaker. According to one embodiment, voice models of frequently recognized speakers can be stored locally with an associated device/system for ready access and use. Social model updates can be performed locally and/or with the assistance of one or more server computers. As described above, social graph 512 and the associated social graph data can be used to proactively retrieve appropriate voice models and provide speaker recognition features.

FIG. 5C depicts another type of social graph 518 generated for user A using additional information that comprises location data and/or recognition data associated with other recognized speakers. As shown, social graph 518 includes three different voice models associated with user A: voice model 520 associated with a first location, voice model 522 associated with a second location, and voice model 524 associated with a third location. The social graph 518 is representative of speakers and their locations (when detected by user A's devices/systems). As an example proactive voice model retrieval, user A's smartphone can be configured to request voice models of users B, C, D as user A travels to location 1.

The additional information comprising a list of recognized speakers for user A (Format: [Speakers], Specific location):

[A, C], Location A in Bellevue;

[A, B, C, D], Location A in Bellevue;

[A, C, D], Location A in Bellevue;

[A. C], Location A in Bellevue;

[A, F], Location B in San Francisco;

[A, G], Location B in San Francisco; and

[A, K, L], Location Home in Redmond.

As an example of proactive voice model retrieval, even if there is no direct relationship among users B, C, and D, user B's device/system can predict some unknown user(s) from user A's social graph 518. For example, the user's B device/system can automatically retrieve voice models of users C and D if available for sharing, since they have been with user A at prior meetings. If the user A is at home, a device/system of user A can automatically retrieve the voice models of users K and L. Likewise, if user A is in San Francisco, a device/system of user A can automatically retrieve the voice models of users F and G. While a few social graph examples have been shown and described it will be appreciated that other types of social graph depictions can be implemented.

It will be appreciated that various features described herein can be implemented as part of a processor-driven environment including hardware and software components. Also, while certain embodiments and examples are described above for illustrative purposes, other embodiments are included and available, and the described embodiments should not be used to limit the claims. Suitable programming means include any means for directing a computer system or device to execute steps of a process or method, including for example, systems comprised of processing units and arithmetic-logic circuits coupled to computer memory, which systems have the capability of storing in computer memory, which computer memory includes electronic circuits configured to store data and program instructions or code.

An exemplary article of manufacture includes a computer program product useable with any suitable processing system. While a certain number and types of components are described above, it will be appreciated that other numbers and/or types and/or configurations can be included according to various embodiments. Accordingly, component functionality can be further divided and/or combined with other component functionalities according to desired implementations. The term computer readable media as used herein can include computer storage media or computer storage. The computer storage of an embodiment stores program code or instructions that operate to perform some function. Computer storage and computer storage media or readable media can include volatile and nonvolatile, removable and non-removable media implemented in any method or technology for storage of information, such as computer readable instructions, data structures, program modules, etc.

System memory, removable storage, and non-removable storage are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of a device or system. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components which include, but are not limited to, wide area networks (WANs), local area networks (LANs), metropolitan area networks (MANs), proprietary networks, backend networks, cellular networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions.

Terms used in the description, such as component, module, system, device, cloud, network, and other terminology, generally describe a computer-related operational environment that includes hardware, software, firmware and/or other items. A component can use processes using a processor, executable, and/or other code. Exemplary components include an application, a server running on the application, and/or an electronic communication client coupled to a server for receiving communication items. Computer resources can include processor and memory resources such as: digital signal processors, microprocessors, multi-core processors, etc. and memory components such as magnetic, optical, and/or other storage devices, smart memory, flash memory, etc. Communication components can be used to communicate computer-readable information as part of transmitting, receiving, and/or rendering electronic communication items using a communication network or networks, such as the Internet for example. Other embodiments and configurations are included.

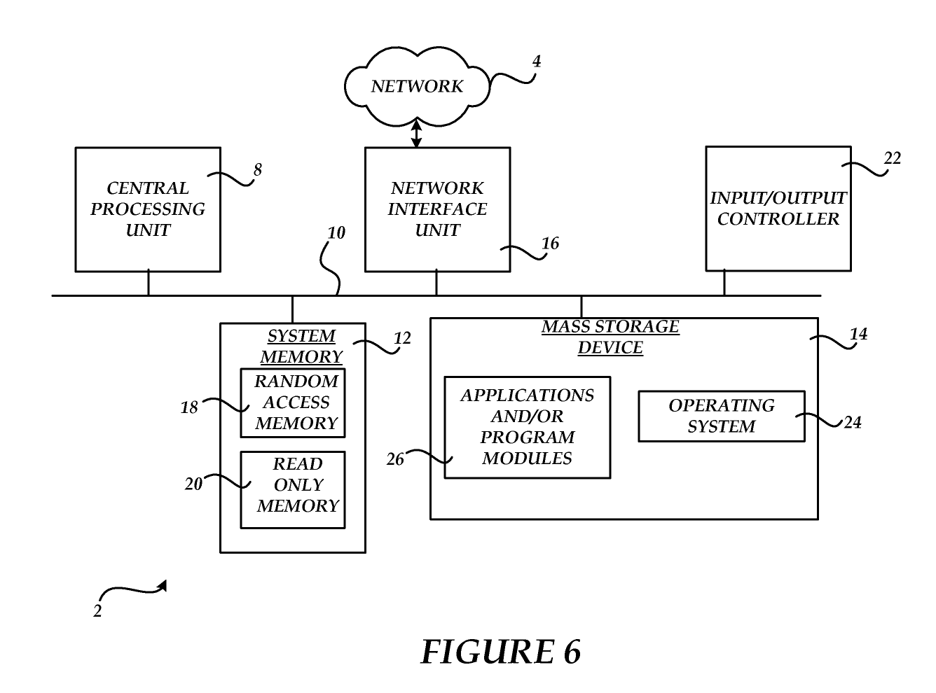

Referring now to FIG. 6, the following provides a brief, general description of a suitable computing environment in which speaker recognition embodiments can be implemented. While described in the general context of program modules that execute in conjunction with program modules that run on an operating system on various types of computing devices/systems, those skilled in the art will recognize that the invention may also be implemented in combination with other types of computer devices/systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 6, computer 2 comprises a general purpose server, desktop, laptop, handheld, or other type of computer capable of executing one or more application programs including an email application or other application that includes email functionality. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules/resources 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

According to various embodiments, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

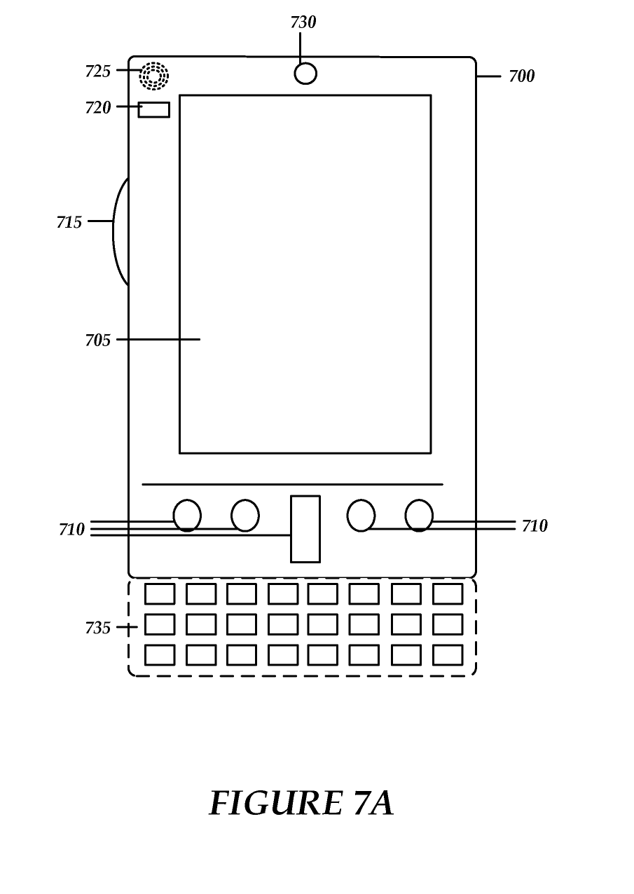

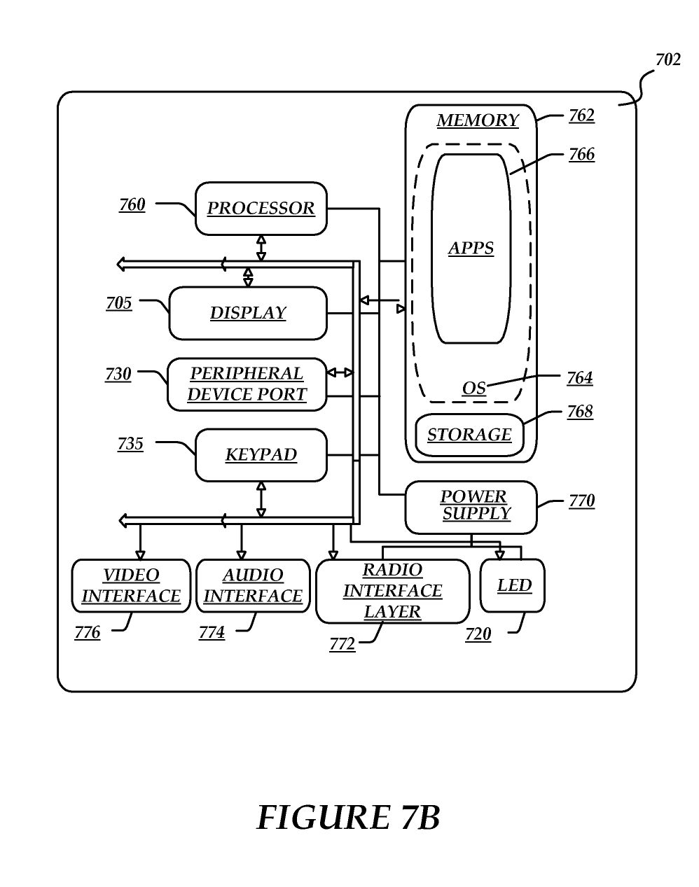

FIGS. 7A-7B illustrate a mobile computing device 700, for example, a mobile telephone, a smart phone, a tablet personal computer, a laptop computer, and the like, with which embodiments may be practiced. With reference to FIG. 7A, one embodiment of a mobile computing device 700 for implementing the embodiments is illustrated. In a basic configuration, the mobile computing device 700 is a handheld computer having both input elements and output elements.

The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone.

The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 700 can incorporate a system (i.e., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs 766, including a notes application, may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down.

The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries. The system 702 may also include a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 766 via the operating system 764, and vice versa.

The visual indicator 720 may be used to provide visual notifications and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device.

The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments, the microphone may also serve as an audio sensor to facilitate control of notifications, as will be described below. The system 702 may further include a video interface 776 that enables an operation of an on-board camera 730 to record still images, video stream, and the like. A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

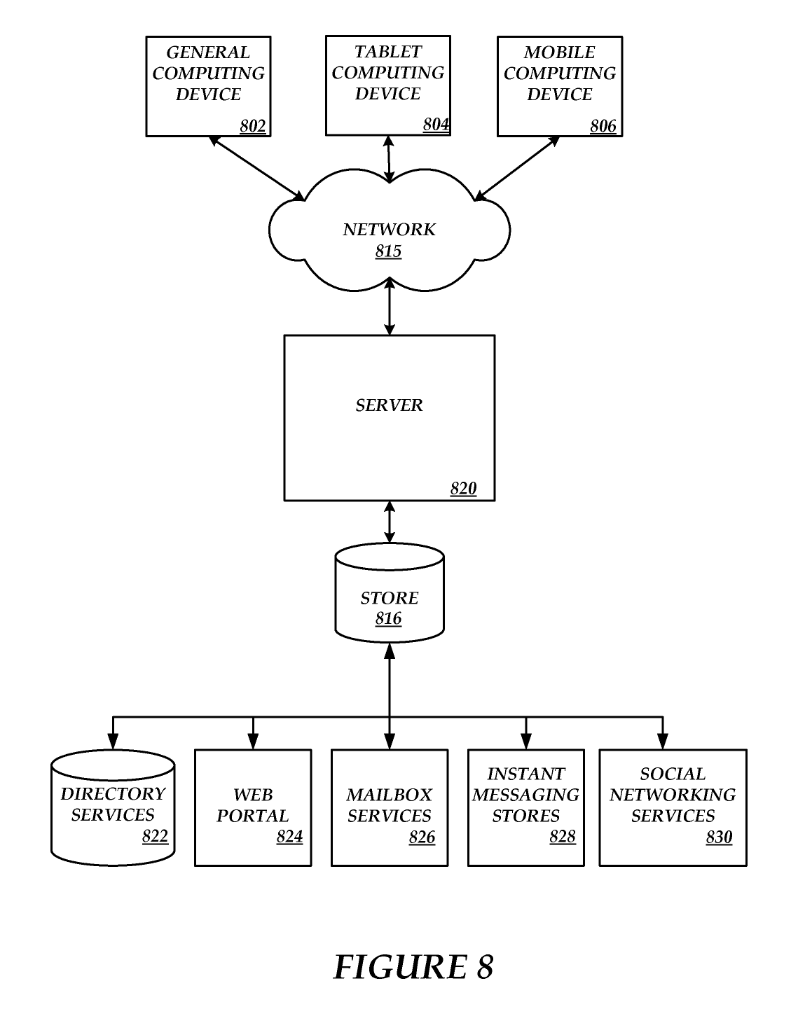

FIG. 8 illustrates one embodiment of a system architecture for implementing proactive voice modelling and/or sharing features. Data processing information may be stored in different communication channels or storage types. For example, various information may be stored/accessed using a directory service 822, a web portal 824, a mailbox service 826, an instant messaging store 828, and/or a social networking site 830. A server 820 may provide additional processing and other features. As one example, the server 820 may provide rules that are used to distribute voice models over network 815, such as the Internet or other network(s) for example. By way of example, the client computing device may be implemented as a general computing device 802 and embodied in a personal computer, a tablet computing device 804, and/or a mobile computing device 806 (e.g., a smart phone). Any of these clients may use content from the store 816.

Embodiments, for example, are described above with reference to block diagrams and/or operational illustrations of methods, systems, computer program products, etc. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

It should be appreciated that various embodiments can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A device configured to:
analyze voice data associated with one or more speakers;
identify an unknown speaker as a known speaker and automatically create a voice model for the known speaker;
proactively retrieve any relevant voice models for use in speaker recognition operations; and
build out a voice model collection associated with a social network including building out voice models of one or more users associated with the social network.

2. The device of claim 1, further configured to generate social graph data which can be used to proactively retrieve a relevant voice model.

3. The device of claim 1, further configured to share voice models based in part on sharing policies.

4. The device of claim 1, further configured to use additional information to anticipate retrieval of pertinent voice models including using a speaker recognition history as part of identifying voice models of different types.

5. The device of claim 1, further configured to retrieve and use an appropriate voice model based on an associated device/system.

6. The device of claim 1, further configured to store voice models associated with various users, various applications, and various contexts locally or using a dedicated server computer.

7. The device of claim 1, further configured to perform inference operations using signal, application, context, or other data.

8. The device of claim 1, further configured to manage voice model parameters locally or with a dedicated server computer.

9. The device of claim 1, further configured to use the voice data to build out voice models for trusted users.

10. The device of claim 1, further configured to create new speaker models using recorded audio data automatically or semi-automatically, wherein the new speaker models correspond to audible utterances of speakers captured by the device.

11. The device of claim 1, further configured to store voice data and voice models using a cloud-based networking environment that uses encryption for data security.

12. An article of manufacture including programming configured to:
analyze voice data to identify one or more speakers;
identify one or more voice models associated the one or more speakers;
allow sharing of the one or more voice models based on sharing policies; and
proactively retrieve one or more relevant voice models for events that include the one or more speakers in part by using additional information that includes social graph data.

13. The article of manufacture of claim 12, wherein the programming operates further to anticipate voice models to retrieve and store locally based on context, application data, and other signals.

14. The article of manufacture of claim 12, wherein the programming operates further to store a speaker recognition history and use the speaker recognition history to generate social graphs that depict speaker and voice model relationships relative to a device owner.

15. The article of manufacture of claim 14, wherein the programming operates further to use social graph data to proactively retrieve appropriate voice models.

16. The article of manufacture of claim 12, wherein the programming operates further to generate tuple objects for social graph data of one or more known speakers.

17. A method comprising:
analyzing voice data to generate one or more voice models associated with one or more speakers;
controlling sharing of the one or more voice models; and
using signal data and other data to identify and proactively retrieve one or more relevant voice models for a future event.

18. The method of claim 17, further comprising building out voice models for other trusted users.

19. The method of claim 17, further comprising generating a social graph based in part on a speaker recognition history associated with an amount of time, a location, and/or application data.

20. The method of claim 17, wherein the other data includes application data, context data, and/or signal data.
